(19) United States
(12) Patent Application Publication
(10) Pub. No.: US 2010/0201630 A1
(43) Pub. Date: Aug. 12, 2010

(54) HOT KEY OPERATION MODULE

(75) Inventor: Chou-Hang Yang, Hsinchu (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: DARFON ELECTRONICS CORP., Taoyuan (TW)

(21) Appl. No.: 12/703,045

(22) Filed: Feb. 9, 2010

(30) Foreign Application Priority Data
Feb. 10, 2009 (TW) 098201899

(51) Int. Cl. G06F 3/02; G06F 3/041

(52) U.S. Cl. 345/172; 345/173

(57) ABSTRACT

A hot key operation module is disclosed. The hot key operation module includes a hot key and a touch panel. When a user presses the hot key, a host will display a graphical user interface on a screen, wherein the graphical user interface includes an operation block. The profile of the graphical user interface is similar to that of the touch panel. The user can operate the touch panel according to the relative position of the operation block relative to the graphical user interface, so as to drive the host to execute the function corresponding to the operation block.

### BACKGROUND OF THE INVENTION

1. Field of the invention

The present invention relates to a hot key operation module, and more particularly, to a hot hey operation module that can reduce the time to search hot keys of different functions and provide more intuitive hot key operation for a user.

2. Description of the prior art

The technology of current world develops rapidly with each passing days, and is already different from that of the industry and commerce society and the rural society in the past days. With the incoming age of information and the popularization of computer applications, the internet spreads far and fast. By connecting to the internet through a personal computer, all kinds of information are available at hand. Common electronic appliances, such as a personal computer (PC), a notebook computer and a personal digital assistant (PDA), are widely accepted by common people because of the advantages of the lowered costs, improved functions, smaller volume, light-weighted and user interface with more affinity. In addition, the electronic appliances can adopt the technique of graphical user interface (GUI) on the display thereof so that the user can control the functions of the electronic appliances simply and swiftly by the moving and clicking of the cursor displayed on the display.

With the growth of electronic technology, the computer has great improvement whether in the hardware or software. As for a personal computer nowadays, the computing speed thereof is already no less than that of the small computer in the past days. Moreover, in addition to greater and more functions, the operating system and the application software based on the personal computer nowadays further have the user interface with greater affinity.

The windows operating system of the personal computer and application software of various multimedia are with such powerful functions that it would be inconvenient to operate with the existing keyboard with only 101 keys. Therefore, to enhance the controlling ability and operating speed in multimedia for a user, many multimedia computer devices, such as notebook computer and desktop computer, are provided with various quantity of hot keys cooperated with hot key control method of the hot key control program to manage the operation of the multimedia.

In the past days, when users want to start-up an application program, mostly they have to access the directory where the application program is located folder by folder and execute the application program to complete the start-up. Otherwise, the user has to execute the “start” function provided by the operating system and further select the function-option from the program list to execute the application program. Therefore, to save the operating time of a user, the software or computer manufacturer have added hot key and shortcut function described hereinabove, so that the user can start up a application software rapidly.

In the aspect of processing procedure for the hot key functions described hereinabove, two ways to provide the hot key functions are described as follows. One way is to first generate a scan code by a keyboard controller (KBC), and then execute the hot key function according to the scan code by a pre-designed application software (that is, the driver of the keyboard). The other way is to control the serial control interface (SCI) to generate control signals by using the programming code of the advance configuration and power interface source language (ASL) to manage the hot keys.

In general, the hot key function is realized by loading the application software when running the operating system, such as Windows. The application software determines whether the function of the preset hot key should be enabled according to the scan code generated by the keyboard controller. If the hot key is determined to function, the application software then outputs a system management interrupt (SMI) signal and acquires the hot key which functions according to the system management interrupt signal.

To facilitate the operation of the software which is often used, the notebook computers are mostly designed with hot keys. In a conventional notebook computer, the hot keys are often disposed on the top or two lateral sides of the keyboard. However, the quantity of the hot keys increases while the functions of the computer software increase with each passing days. Excessive hot keys will not only cause the problem when the user searches different hot keys, but also lessens the purpose and significance of fast operation for the hot keys.

In regard to this, the main objective of the present invention is to provide a hot key operation module. The hot key operation module integrates the concept of modularization into to the design of the keyboard of a notebook computer in such a way that the hardware hot keys are used to trigger the corresponding software functions while the panel is used to operate the software hot keys displayed on the screen. Thereby, in addition to the reduction of the quantity of the hot keys and the time required for a user to search the different hot keys, more intuitive operation of hot keys are provided to the user.

### SUMMARY OF THE INVENTION

The objective of the present invention is to provide a hot key operation module. The hot key operation module can be applied to a host which has a screen. The hot key operation module mainly includes hot keys and a touch panel.

The hot keys are electrically connected to the host. When a user presses the hot keys, the host displays a graphical user interface on the screen. The graphical user interface includes an operation block.

The touch panel is electrically connected to the host. The profile of the graphical user interface is similar to the profile of the touch panel. The user can operate the touch panel according to a relative position of the operation block relative to the graphical user interface, so as to drive the host to execute a function corresponding to the operation block.

Comparing to the conventional technology, the hot key operation module of the present invention integrates the concept of modularization into the design of the keyboard of a notebook computer in such a way that the hardware hot keys are used to trigger the corresponding software functions while the panel is used to operate the software hot keys displayed on the screen. Thereby, in addition to the reduction of the quantity of the hot keys and the time required for a user to search the different hot keys, more intuitive operation of the hot keys are provided to the user.

The advantage and spirit of the invention may be understood by the following recitations together with the appended drawings.

### BRIEF DESCRIPTION OF THE APPENDED DRAWINGS FIG. 1 is a schematic view of the hot key operation module of the present invention for use in a notebook computer.

FIG. 2A is a schematic view of the graphical user interface of the first preferred embodiment of the present invention.

FIG. 2B is a schematic view of the graphical user interface of the second preferred embodiment of the present invention.

FIG. 2C is a schematic view of the graphical user interface of the third preferred embodiment of the present invention.

### DETAILED DESCRIPTION OF THE INVENTION

The present invention provides a hot key operation module. More particularly, the hot key operation module uses the hardware hot key to trigger the corresponding software functions and uses the touch panel to operate the software hot keys displayed on the screen. The preferred embodiment of the present invention will be described in detail as follows to fully explain the characteristic, spirit, advantage and convenience in practice of the present invention.

In reference to FIG. 1, a schematic view of the hot key operation module 10 according to one embodiment of the present invention is depicted therein. The hot key operation module 10 is for use a notebook computer 1. As illustrated in FIG. 1, the hot key operation module 10 can be applied to, but not limited to, the input interface of the common notebook computer. In other words, any electronic device can easily introduce the hot key operation module 10 of the present invention to activate the hot key function provided that the electronic device has an input interface. The detailed description of the hot key operation module 10 of the embodiment, including the structure, functions and principle of the elements, will be described as follows.

As illustrated in FIG. 1, the host (that is, the notebook computer 1) includes a screen 12. The hot key operation module 10 of the present invention mainly includes a plurality of hot keys (such as the multimedia operating hot key 100a, the phone dialer hot key 100b and the display output selection hot key 100c in FIG. 1) and a touch panel 102. More particularly, the hot keys are disposed along the periphery of the touch panel 102. Thereby, the time required to search different hot keys by the user can be effectively reduced.

As also shown in FIG. 1, the hot keys of the hot key operation module 10 of the present invention are respectively connected to the host. When the user presses any one of the hot keys, the host will display the graphical user interface 120 corresponding to the pressed hot key. The graphical user interface 120 includes a plurality of operation blocks 1200. Each operation block 1200 has different function.

Furthermore, the touch panel 102 of the hot key operation module 10 of the present invention is electrically connected to the host. It should be emphasized that the profile of the graphical user interface 120 described hereinabove is the similar to the profile of the touch pad 102. That is to say, the profiles of the graphical user interface 120 and the touch panel 102 are the same in regard to the geometry, but not necessarily the same in actual size. For example, to make the user clearly indentify and understand the position and the function of each operation block 1200, the designer of the application software may design the user graphical interface 120 displayed on the screen 12 with a size greater than the actual size of the touch panel 102. Thereby, the user can easily operate the touch panel 102 according to the relative position of the chosen operation block 1200 relative to the graphical user interface 120, so as to further drive the host to execute the function corresponding to the chosen operation block 1200.

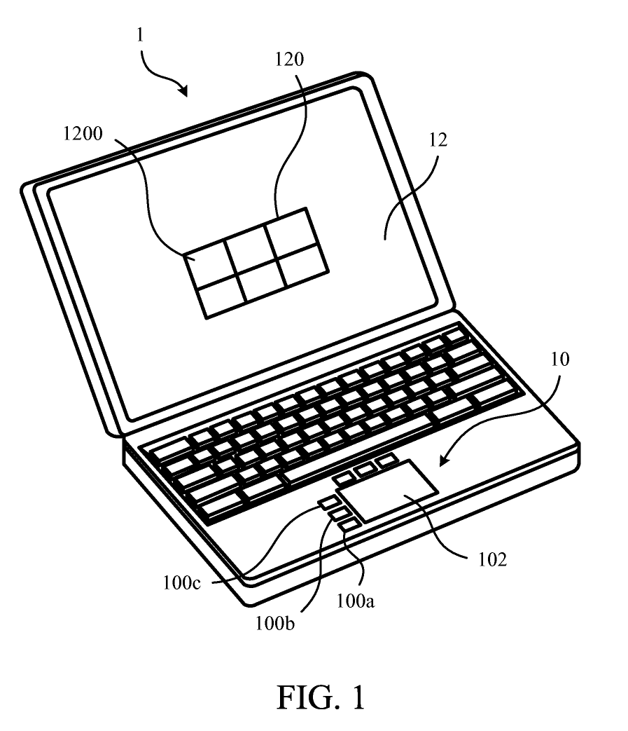

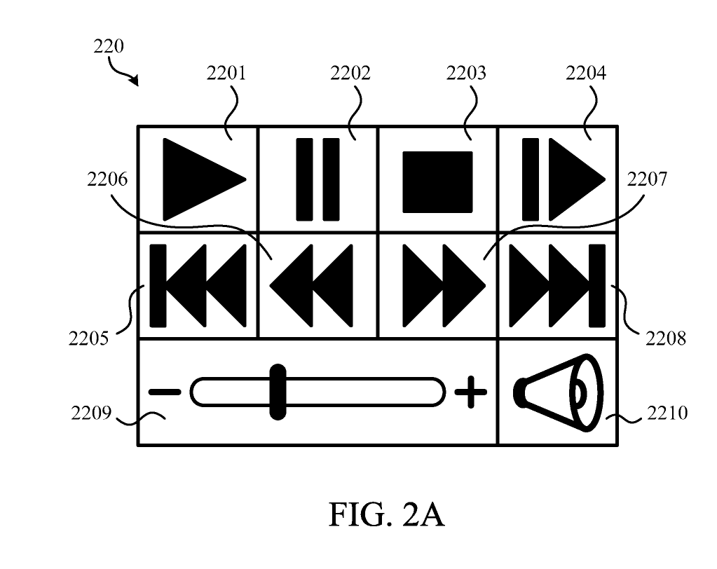

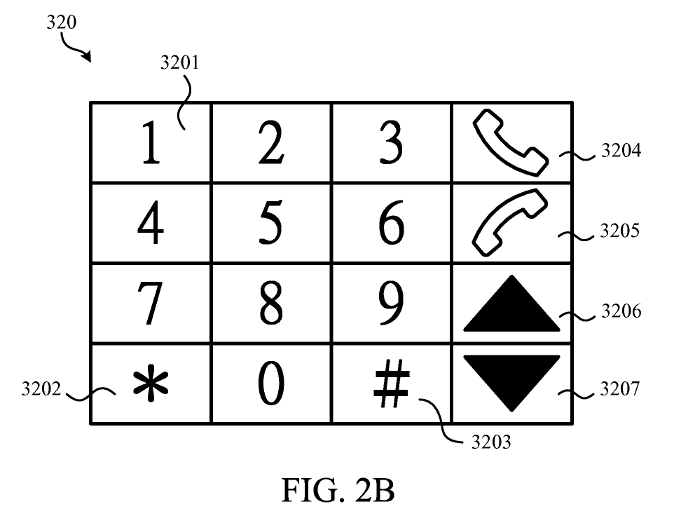

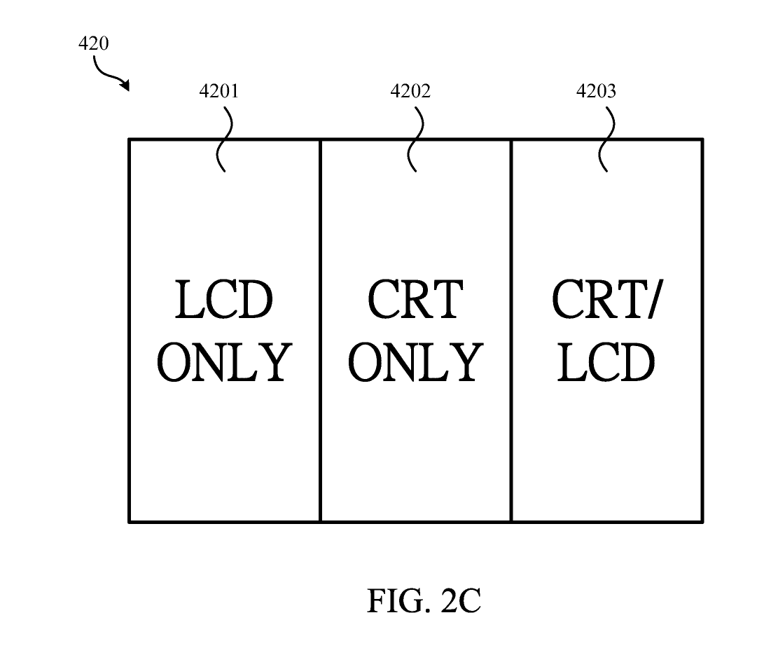

Please refer to FIG. 2A along with FIG. 1. FIG. 2 depicts a schematic view of the graphical user interface 120 of the first preferred embodiment of the present invention. As shown in FIG. 2A, the multimedia operating interface 220 is taken as an example of the graphical user interface 120 of this preferred embodiment. When the user presses the multimedia operating hot key 100a, the host will display the corresponding user graphical interface 120 (that is, the multimedia operating interface 220) on the screen 12. As shown in FIG. 2A, the multimedia operating interface 220 has the operation blocks, including the play block 2201, the pause block 2202, the stop block 2203, the frame-enlarging block 2204, the fast-forward block, 2208, the fast-reverse block 2205, the fast-play block 2207, the slow-play block 2206, the volume control block 2209, and the mute block 2210, but not limited to the operation blocks 2201 to 2210 hereinabove. That is to say, under the condition of actual need or limit of the design, people in the art can flexibly implement the operation blocks 2201 to 2210 regarding to the multimedia operating function into the hot key operation module 10 of the present invention. For example, when the user wants to see a film, the user can press the relative position on the touch panel 102 corresponding to the play block 2201 of the multimedia operating interface 220. When the user wants to pause the film that is currently playing, the user can press relative position on the touch panel 102 corresponding to the pause block 2202 on the multimedia operating interface 220. When the user wants to stop playing the film, the user can press the relative position on the touch panel 102 corresponding to the stop block 2203 on the multimedia operating interface 220. When the user wants to inspect a specific scene of the film, the user can press the relative position on the touch panel 102 corresponding to the frame-enlarging block 2204 on the multimedia operating interface 220. When the user wants to see the later clip of the film and skip the current clip, the user can press the relative position on the touch panel 102 corresponding to the fast-forward block 2208 on the multimedia operating interface 220. When the user wants to see the previous clip of the film and skip the current clip, the user can press the relative position on the touch panel 102 corresponding to the fast-reverse block 2205 on the multimedia operating interface 220. When the user wants to see the film with faster playing speed, the user can press the relative position on the touch panel 102 corresponding to the fast-play block 2207 on the multimedia operating interface 220. When the user wants to see the film with slower playing speed, the user can press the relative position on the touch panel 102 corresponding to the slow-play block 2206 on the multimedia operating interface 220. When the user wants to adjust the volume of the film, the user can press the relative position on the touch panel 102 corresponding to the volume control block 2209 on the multimedia operating interface 220. When a user wants to turn off the sound of the film temporary, the user can press the relative position on the touch panel 102 corresponding to the mute block 2210 on the multimedia operating interface 220. In addition to play the film, the multimedia operating interface 220 can be used to play the music.

Referring to FIG. 2B, a schematic view of the user graphical interface 120 of the second preferred embodiment of the present invention is depicted. As shown in FIG. 2B, the phone dialer interface 320 is take as an example of the graphical user interface 120 of this preferred embodiment. When the user presses the phone dialer hot key 100b, the host will display the corresponding user graphical interface 120 (that is, the phone dialer interface 320) on the screen 12. As shown in FIG. 2B, the phone dialer interface 320 has the operation blocks, including the number block 3201, the star key block 3202, the pound key block 3203, the call-receiving/confirm block 3204, the hang-up/cancel block 3205, the previous message block 3206, and the next message block 3207, but not limited to the operation blocks 3201 to 3207 hereinabove. That is to say, under the condition of actual need or limit of the design, people in the art can flexibly implement the operation blocks 3201 to 3207 regarding to the phone dialer function into the hot key operation module 10 of the present invention.

For example, when the user wants to dial the internet phone, the user can press the relative positions on the touch panel 102 corresponding to number block 3201, the star block 3202 or the pound block 3203 on the phone dialer interface 320 in an order, and then press the relative positions on the touch panel 102 corresponding to the call-receiving/confirm block 3204 on the phone dialer interface 320 to dial the number of a internet phone or a cell phone. When the user wants to end a call, the user can press the relative position on the touch panel 102 corresponding to the hang-up/cancel block 3205 on the phone dialer interface 320. When the user wants to check the message from the internet phone, the user can press the touch panel 102 corresponding to the previous message block 3206 or the next message block 3207 on the phone dialer interface 320 to move the selecting cursor to the message of interest, and then press the relative position on the touch panel 102 corresponding to the call-receiving/confirm block 3204 to view the message. When the user finishes reading the message, the user can press the relative position on the touch panel 102 corresponding to the hang-up/cancel block 3205 to close the message. In addition to the previous message block 3206 and next message block 3207, the phone dialer interface 320 can further include a moving left block and a moving right block (not shown in FIG. 2B) to further provide the function to move in two dimension.

Referring to FIG. 2C, a schematic view of the user graphical interface 120 of the third preferred embodiment of the present invention is depicted. As shown in FIG. 2C, the display output selection interface 420 is take as an example of the graphical user interface 120 of this preferred embodiment. When the user press the display output selection hot key 100c, the host will display the corresponding user graphical interface 120 (that is, the display output selection interface 420) on the screen 12. As shown in FIG. 2C, the display output selection interface 420 has the operation blocks, including the monitor output block 4201, the projector output block 4202 and the monitor/projector output block 4203, but not limited to the operation blocks 4201 to 4203 hereinabove. That is to say, under the condition of actual need or limit of the design, people in the art can flexibly implement the operation blocks 4201 to 4203 regarding to the function of display out selection into the hot key operation module 10 of the present invention.

For example, when the user wants the image of host output on the monitor, the user can press the relative position on the touch panel 102 corresponding to the monitor output block 4201 on the display output selection interface 420. When the user wants the image of the host output by the projector, the user can press the relative position on the touch panel 102 corresponding to the projector output block 4202 on the display output selection interface 420. When the user wants the image of the host output both on the monitor and by the projector, the user can press on the relative position on the touch panel 102 corresponding to the monitor/projector output block.

What should be implemented is here that although the present invention are described in terms of the examples of three preferred embodiment described hereinabove, the present invention is not limited to the three graphical user interface 220, 320 and 420 described hereinabove in practical application. As long as the function of the application software can be performed with the operating method of the present invention by pressing the relative position on the touch panel 102 corresponding to the graphical user interface, the application software can be carried out through the implement of the hot key operation module 10.

With the detailed description of the preferred embodiment of the present invention described hereinabove, it can be easily pointed out that the hot key operation module of the present invention integrates the concept of modularization into the design of the hot keys of a notebook computer. With this design, the operation area can be more compact. The hardware hot key is used to trigger the corresponding function of the software, while the touch panel is used to control the software hot key displayed on the screen. Thereby, in addition to the reduction of the quantity of the hot keys and the time required for a user to search the different hot keys, more intuitive operation of the hot keys are provided to the user.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A hot key operation module for use in a host, the host having a screen, the hot key operation module comprising:
a hot key electrically connected to the host, when a user presses the hot key, the host displaying a graphical user interface on the screen, wherein the graphical user interface includes an operation block; and
a touch panel electrically connected to the host, wherein a profile of the graphical user interface is similar to a profile of the touch panel, and the user operates the touch panel according to a relative position of the operation block relative to the graphical user interface, so as to drive the host to execute a function corresponding to the operation block.

2. The hot key operation module of claim 1, wherein the hot key is disposed at a periphery of the touch panel.

3. The hot key operation module of claim 1, wherein the graphical user interface is a multimedia operating interface, and the operation block is one selected from the group consisting of a play block, a pause block, a stop block, a frame-enlarging block, a fast-forward block, a fast-reverse block, a fast-play block, a slow-play block, a volume control block and a mute block.

4. The hot key operation module of claim 1, wherein the graphical user interface is a phone dialer interface, and the operation block is one selected from the group consisting of a number block, a star key block, a pound key block, a call-receiving/confirm, block, a hang-up/cancel block, a previous message block and a next message block.

5. The hot key operation module of claim 1, wherein the graphical user interface is a display output selection interface, and the operation block is one selected from the group consisting of a monitor output block, a projector output block and a monitor/projector output block.
